(19) United States
(12) Patent Application Publication
(10) Pub. No.: US 2023/0149949 A1
(43) Pub. Date: May 18, 2023

(54) Filter Element With Magnetic Array

(71) Applicant: Fleenor Manufacturing, Inc., Pella, IA (US)

(72) Inventors: Jeff Fleenor, Pella, IA (US); Kurtis Stockdale, Pella, IA (US)

(21) Appl. No.: 18/092,753

(22) Filed: Jan. 3, 2023

Related U.S. Application Data
(63) Continuation of application No. 15/570,332, filed on Oct. 28, 2017.
(60) Provisional application No. 62/154,465, filed on Apr. 29, 2015.

(51) Int. Cl. B03C 3/66; B03C 1/033; B03C 1/034; B03C 1/28; B03C 1/30; B03C 3/47; B03C 3/82

(52) U.S. Cl. CPC B03C 3/66; B03C 1/0332; B03C 1/034; B03C 1/288; B03C 1/284; B03C 1/30; B03C 1/286; B03C 3/47; B03C 3/82; B03C 2201/18; B03C 2201/28

(57) ABSTRACT

A filter for removing ferrous particles from a fluid. The filter has an outer filter housing and a non-ferrous liner inside the housing. A plurality of magnets are longitudinally extended at intervals outside the liner. An insert inside the liner imparting a directional flow to the fluid inside the filter whereby ferrous particles in the fluid are trapped by the magnets and held against the non-ferrous line.

### CROSS-REFERENCE TO RELATED APPLICATION(S)

This application is a continuation of U.S. application Ser. No. 15/570,332 filed Oct. 28, 2017, entitled “Filter Element with Magnetic Array,” which claims priority to International PCT Application No. PCT/US16/30119 filed on Apr. 29, 2016, which claims priority to U.S. Provisional Application No. 62/154,465 filed Apr. 29, 2015, and entitled “Filter Element with Magnetic Array,” each of which is hereby incorporated by reference in its entirety.

### BACKGROUND OF THE INVENTION

The invention relates generally to filter elements and, more specifically, to a novel, non-obvious filter element having a magnetic array for assisting in the removal of ferrous particles from a fluid flow.

In the process of making hydraulic components, such as gears, pumps, motors, valves and cylinders, ferrous metal particles are produced that contaminate the fluids used in the manufacturing process. These ferrous particles can result in decreased life of the fluid system. Current ISO standards require the removal of particles down to the level of 4 microns. Filters capable of removing particulate contaminants down to 4 microns are expensive and often must Aprilbe combined into a bank of filter elements in parallel or series to handle the amount of fluid flow that must be processed. When filtering oil used in manufacturing processes, magnetic are known for use in removing ferrous contaminants, including even sub-micron sized contaminants, from the fluid flow. Typically, these magnetic filters are a one-time expense and can be placed upstream of traditional filter media to help extend the life of the standard filter, thus reducing overall costs of operation.

In operational systems, such as engines, transmissions, and mobile construction equipment hydraulic systems, iron based contaminates will be generated in the normal wear and tear of operation. Typically, these metal contamination particles are relatively hard and can induce wear in a system. Many times these systems are operated outside in cold environments and putting in a fine filter medium to trap effectively these fine particles can have a negative impact on performance due to the increased pressures from the high viscosity of low temperature oil. Therefore, the filters used tend to be higher in absolute micron rating which allows larger contaminants to flow through the system and ultimately leads to lower component life. Magnetic filters can dramatically improve the filtration of the oil to much finer filtering without the cold weather bypass restrictions of a standard filter.

### SUMMARY OF THE INVENTION

The present invention is a filter element having a magnetic array and which is designed to trap the most abrasive contaminates, which are ferrous based, from a fluid system with a low service cost. The filter element has an outer cylindrical can and a coaxial inner liner with a plurality of axial magnets extending substantially the length of the liner interposed in a cylindrical array either between the liner and the outer can or around the outer can. In contrast to known filters, the magnets are thus placed inside the metal can and so are more effective at trapping ferrous contaminants. The ferrous based contaminates are attracted to the liner by the magnets and held. When it is time to service the magnetic filter, the liner is removed to either be washed and reused, or simply thrown away if the liner can be made cheaply enough. The design should be modular in nature such that multiple filters can be stacked in parallel circuits to slow the flow down to maximize the contaminant removal. In some installations, the parallel system is placed in front of the standard filter to act as both an absolute filter as well as an indicator when to service the system. Other versions could be made to target specific markets such as diesel engines used in transportation and logistics, as well as other markets.

In a preferred embodiment, a spiral baffle is placed inside the filter to increase the flow path of fluid through the filter, thereby also increasing residence time in the filter, and to direct the higher density contaminants toward the liner at outer wall of the filter where the magnetic filed is the strongest and where trapping of the ferrous contaminants is most effective. An advantage of the spiral flow path is that it has a constant cross-sectional area which eliminates restrictions in the fluid flow path. Alternatively, an insert which induces a vortical flow of the fluid along the axis of the filter can be used.

In another preferred embodiment, the magnets are arranged in pairs of alternating polarity. Alternatively, they may be arranged in a spaced relationship with adjacent magnets having alternating polarity.

In another preferred embodiment, multiple filter elements of the present invention are arranged in series to increase the holding capacity of trapped contaminants. Alternatively, multiple magnetic filter elements of the present invention may be arranged in parallel arrays that will slow down the fluid flow through each element, thereby increasing the residence time in each element to allow more time for trapping of the ferrous contaminants. The stacked and parallel arrays can be combined with a filter having standard filtering medium to catch non-ferrous contaminants for absolute filtration capability. The standard filter can then use a pressure differential detection across the filer medium to indicate when to check the magnetic array filter elements for cleaning.

In another embodiment, an air purge can be used to push fluid out of the array to facilitate changing of the filter elements.

In an alternative embodiment, the stacked arrays of the standard filter element and the magnetic array filter elements of the present invention may be assembled in two parallel circuits such that one side of the two parallel circuits can be serviced while the other side remains operational.

There is, accordingly, an interest in developing a magnetic arrays filter element with more effective trapping characteristics and which can be more easily serviced.

### BRIEF DESCRIPTION OF THE FIGURES

FIG. 1 is a cross-sectional view of a filter element of the present invention wherein an insert which induces a vortex in the fluid flow is used.

FIG. 2 is an exploded view of the embodiment of FIG. 1.

FIG. 3 is a perspective view of a filter element of the present invention wherein a spiral-shaped insert is used to direct the fluid in a spiral flow pattern inside the filter element.

FIG. 4 is an exploded view of the embodiment of FIG. 3.

FIG. 5 is a cross-sectional view of the embodiment of FIG. 3.

FIGS. 6a and 6b are alternative arrangements of magnets of the filter elements of the present invention.

FIG. 7a is a side view of an alternative embodiment of the filter of a filter of the present invention; FIG. 7b is a cross-sectional view of the filter of FIG. 7a; FIG. 7c is a partially exploded view of the filter of FIG. 7a wherein the outer pressure wall has been removed to show the interior of the filter.

### DESCRIPTION OF THE INVENTION

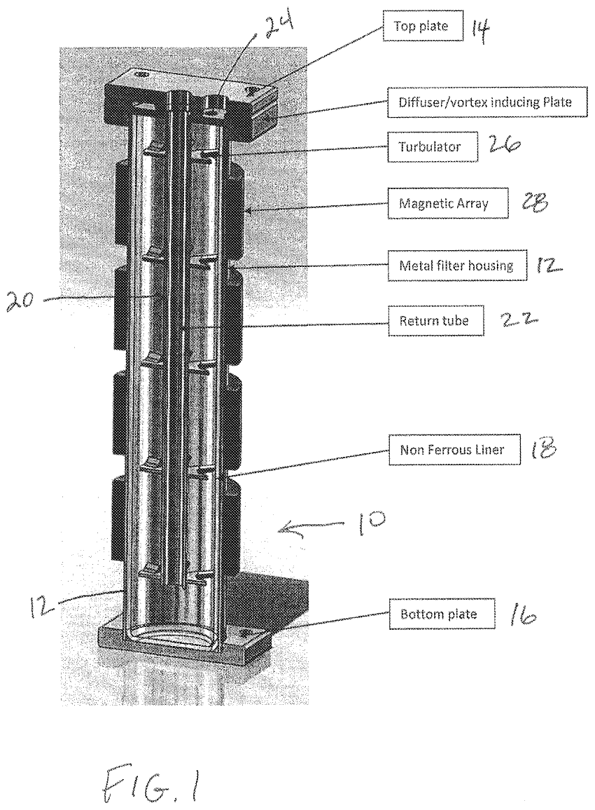

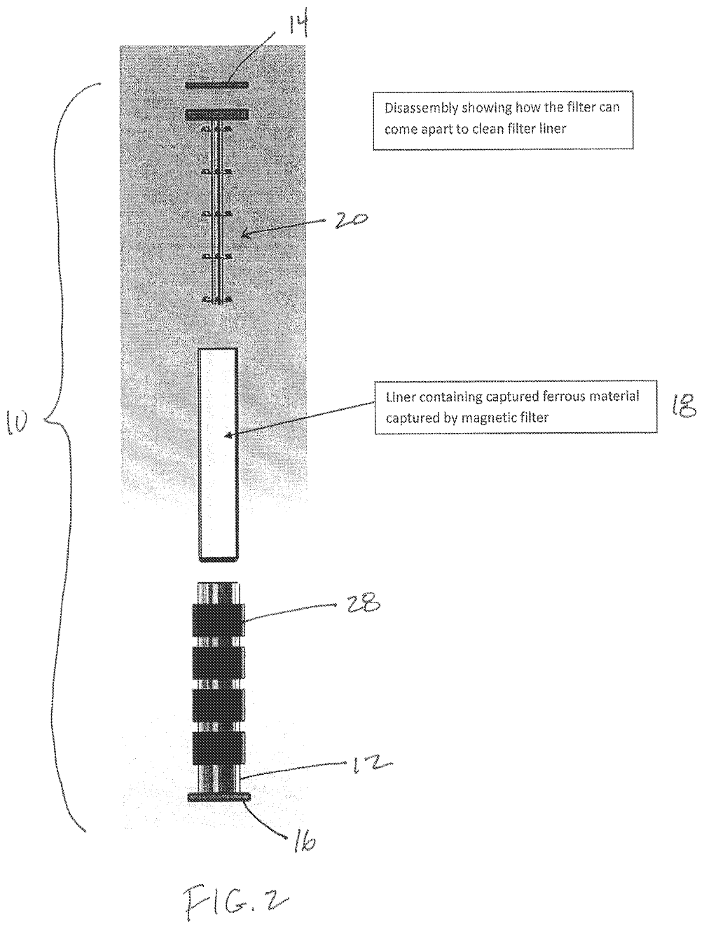

Illustrated in FIGS. 1 and 2, generally at 10, is a preferred embodiment of a filter element of the present invention. The filter element 10 includes a cylindrical filter housing 12 to which is affixed a top plate 14 and a bottom plate 16. A non-ferrous liner 18 is received in a close fit inside the housing 12. An insert 20 extends from the top plate 14 axially down the housing 12, terminating above the bottom plate 16. The insert 20 includes a central return tube 22. Fluid is directed into the filter element 10 through a port 24 in the top plate 14 and is returned to the exterior of the filter element 10 via the return tube 22. The insert 20 preferably has a plurality of radially extended plates 26 that act to introduce a flow pattern to fluid inside the filter element 10. Encircling the exterior of the filter housing 12 are a plurality of annular rings of magnets 28 which will act to attract ferrous contaminants present in the fluid where they will be held against the liner 18.

In certain embodiments, it may be desirable to induce a predetermined flow pattern of the fluid inside the filter element 10 so as to improve the filtering efficiency of the filter element 10. For example, inducing a vortex in the fluid around the longitudinal axis will increase the residence time of the fluid inside the filter element 10 and will also cause a centripetal force that will urge the higher density ferrous contaminants toward the liner 18 and arrays of magnets 28. The vortex can be induced by angling of the port 24 and by selecting a shape and placement of the plates 26 that will help maintain the vortical flow.

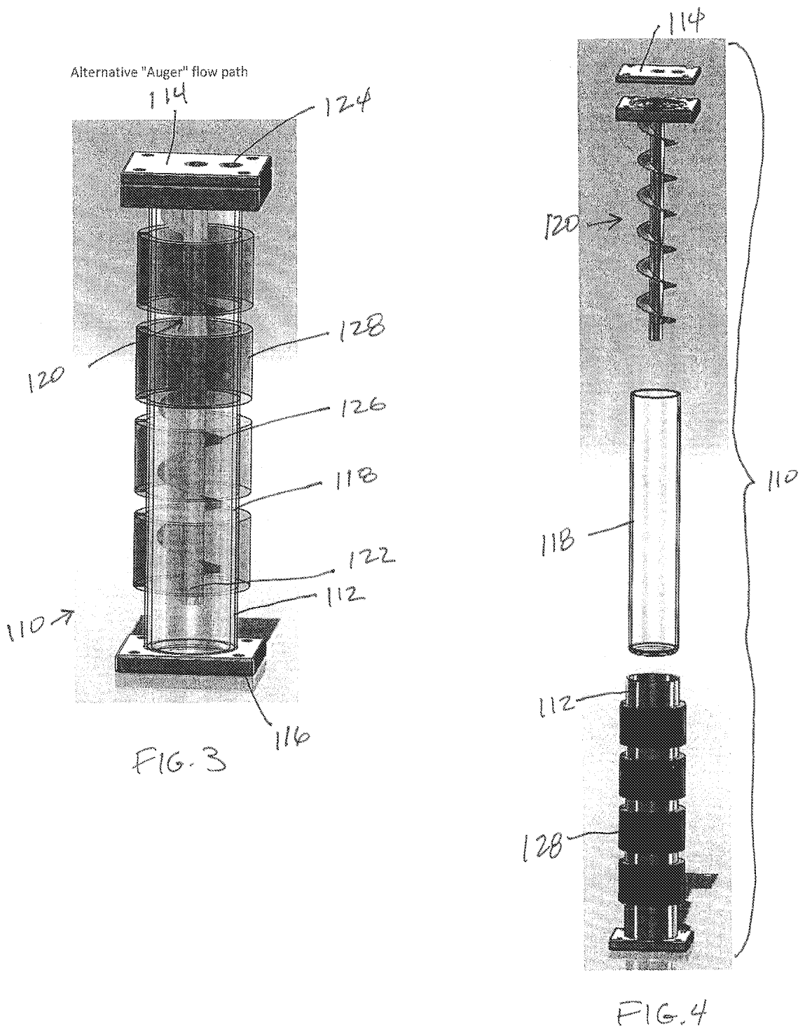

Illustrated in FIGS. 3 and 4, generally at 110 is an alternative embodiment of the present invention filter element. The filter element 110 includes a cylindrical filter housing 112 to which is affixed a top plate 114 and a bottom plate 116. A non-ferrous liner 118 is received in a close fit inside the housing 112. An insert 120 extends from the top plate 114 axially down the housing 112, terminating above the bottom plate 116. The insert 120 includes a central return tube 122. Fluid is directed into the filter element 110 through a port 124 in the top plate 114 and is returned to the exterior of the filter element 110 via the return tube 122. The insert 120 has helical flighting 126 to induce a spiral flow pattern to fluid inside the filter element 110. Encircling the exterior of the filter housing 112 are a plurality of annular rings of magnets 128 which will act to attract ferrous contaminants present in the fluid where they will be held against the liner 118. The helical flighting 126 acts to increase the residence time of fluid inside the filter element 110 and creates a centripetal force that will urge higher density ferrous contaminants into proximity of the liner 118 and magnet arrays 128.

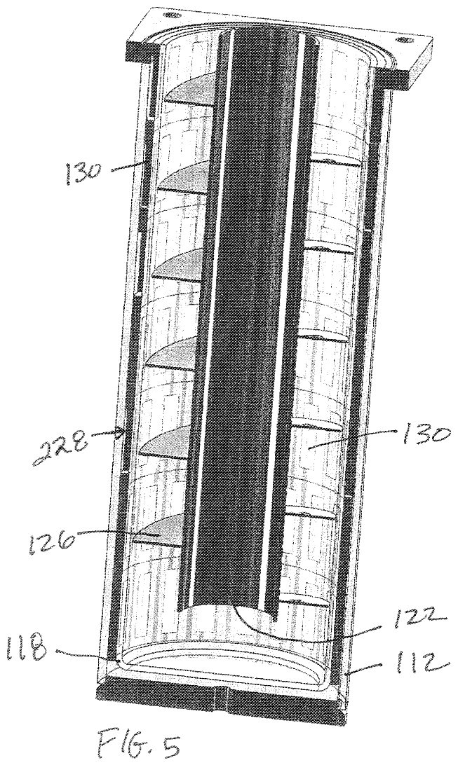

A further preferred embodiment is illustrated generally at 210 in FIG. 5. It is similar to filter element 110 except that the magnet arrays 228, including individual magnets 130, have been placed inside the filter housing 112 but outside the non-ferrous liner 118. By placing the magnet arrays 228 inside the filter housing 112, any shielding effect of the filter housing 112 will be eliminated and the capture of ferrous contaminants improved. If desired, a plurality of openings can be created in the liner 118, preferably not in the areas of the magnets 130, to allow the pressure to equalize on either side of the liner 118.

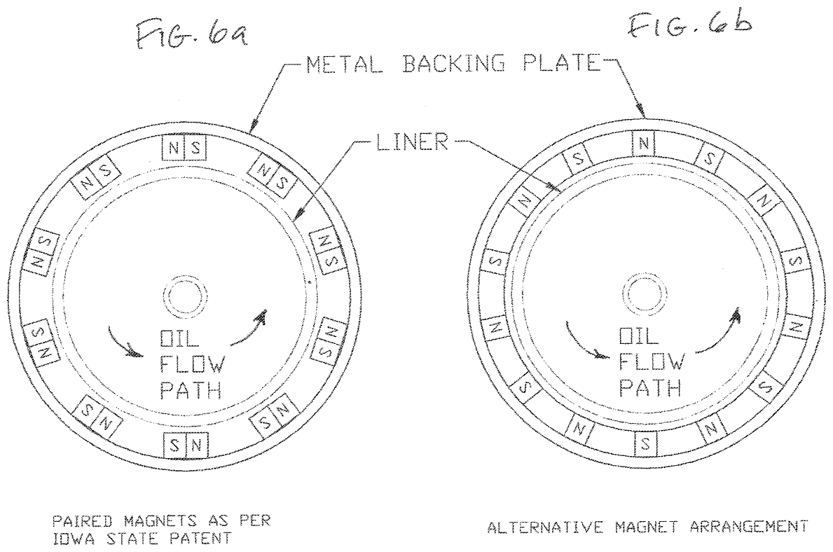

The individual magnets 130 may be arranged in at least two different ways. The magnets may be arranged in adjacent pairs of alternating polarity, as illustrated in FIG. 6a and similar to that described in U.S. Pat. No. 7,662,282 (which is incorporated herein in its entirety by this reference), or as individual magnets spaced apart from each other with alternate magnets having opposite polarity, as illustrated in FIG. 6b.

In certain applications, it may be preferable to provide a port in the bottom plate 16, 116 through which compressed gas can be directed into the filter housing 12, 112, to assist in purging fluid from the filter 10, 110.

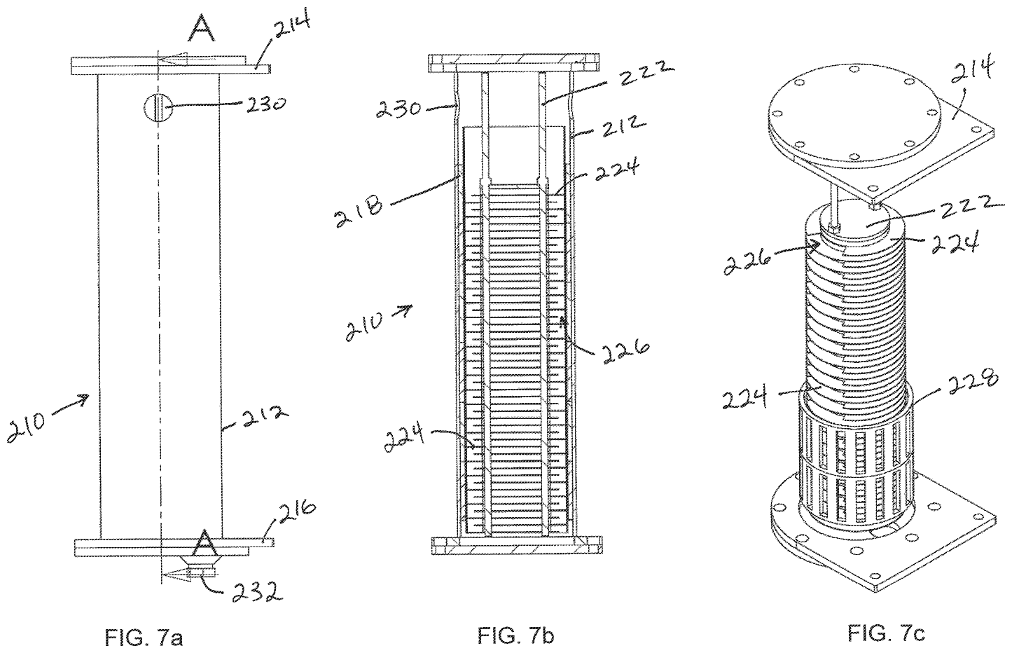

An alternative embodiment is illustrated in FIGS. 7a-7c, wherein the filter is illustrated generally at 210. The filter 210 includes a filter housing or pressure vessel wall 212 to which is affixed atop plate 214 and a bottom plate 216. A non-ferrous liner 218 is received in a close fit inside the housing 212. An insert 220 is comprised of a central, closed spacer tube 222 about which are arranged in a vertically spaced, stacked relationship a plurality of spacer plates 224. Each spacer plate 224 has a partial annular shape wherein a portion of an otherwise annular piece of material has been removed, as at 226 in FIG. 7c. The arrangement of the removed sections 226 alternate from one side of the filter 210 for odd-numbered spacer plates 224 to the opposite side of the filter 210 for even-numbered spacer plates 224.

Oil to be filtered is introduced into the filter 210 at inlet 230 and is removed from the filter 210 at outlet 232. The path of the oil inside the filter 210 is determined by the arrangement of the removed sections 226 of the stacked spacer plates 224. Since the removed sections 226 alternate sides of the filter 210 as described, the oil is forced to go from one side of the filter 210 to the other side as it encounters each spacer plate 224. The path of the oil through the filter 210 is thus increased as is the residence time it spends near the circumferential periphery of the filter 210. The oil thus has a stepped flow path in contrast to the spiral flow path of the filter 10. A series of magnet arrays 228, similar to those described in the other embodiments are arranged outside the filter housing 212 and will serve to trap ferrous contaminants against the non-ferrous liner 218. An advantage of the embodiment filter 210 is that the stacked spacer plates can be easily and inexpensively manufactured, for example, by laser cutting.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A filter comprising:
(a) a cylindrical filter housing defining an elongate lumen, the elongate lumen comprising a first end, a second end, and a center;
(b) a single, removable, non-ferrous liner disposed within the elongate lumen and extending coaxially with the cylindrical filter housing between the first end and the second end;
(c) a plurality of magnets longitudinally extended at intervals outside the single, removable, non-ferrous liner; and
(d) an insert disposed inside the liner for imparting a directional flow to a fluid inside the filter, the insert comprising:
(i) a helical flighting constructed and arranged to induce a spiral flow pattern to fluid inside the cylindrical filter housing and
(ii) an axial return tube for directing filtered fluid outside the filter,
wherein the single, removeable, non-ferrous liner is constructed and arranged to trap ferrous particles and remove ferrous particles from the fluid.

2. A filter as defined in claim 1, wherein the plurality of magnets are placed outside of the cylindrical filter housing.

3. A filter as defined in claim 1, wherein the plurality of magnets are placed inside of the cylindrical filter housing.

4. A filter as defined in claim 1, wherein the plurality of magnets are arranged in cylindrical arrays.

5. A filter as defined in claim 4, wherein a plurality of said cylindrical arrays are stacked between the first end and the second end of the cylindrical housing.

6. The filter of claim 1, wherein the plurality of magnets are arranged in adjacent pairs of alternating polarity.

7. The filter of claim 1, wherein the filter housing is constructed and arranged such that fluid inflow occurs away from the center of the elongate lumen and fluid outflow occurs from the center of the elongate lumen.

8. A filter comprising:
(a) a filter housing defining an elongate lumen having a first end, a second end, and a center;
(b) a single, removeable non-ferrous liner disposed within the elongate lumen and extending between the first end and the second end;
(c) a plurality of magnets longitudinally extended at intervals inside of the housing and outside the single, removeable, non-ferrous liner; and
(d) an insert disposed inside the liner for imparting a directional flow to a fluid inside the filter,
wherein the single, removeable non-ferrous liner is constructed and arranged to trap and remove ferrous particles from the fluid, wherein the filter is constructed and arranged such that fluid passes through the filter in a spiral pattern, and wherein the single, removeable non-ferrous liner is constructed and arranged such that the single, removeable non-ferrous liner may be removed from the filter housing.

9. The filter of claim 8, fighter comprising spiral flighting.

10. A filter comprising:
(a) a filter housing comprising:
(i) a top plate;
(ii) a bottom plate; and
(iii) a cylindrical body;
(b) a unitary, removeable, non-ferrous liner disposed inside the housing;
(c) an insert comprising:
(i) a return tube and
(ii) a baffle; and
(d) a magnetic array,
wherein the baffle imparts a flow pattern upon a fluid, and wherein the magnetic array attracts ferrous particles within the fluid and holds the ferrous particles against the liner.

11. The filter of claim 10, wherein the magnetic array is disposed inside of the filter housing and outside the unitary, removeable, non-ferrous liner.

12. The filter of claim 10, wherein the unitary, removeable, non-ferrous liner can be removed from the filter housing, cleaned, and then replaced within the filter housing.

13. The filter of claim 10, wherein the unitary, removeable, non-ferrous liner can be removed from the filter housing and a second unitary, removable, non-ferrous liner is placed within the filter housing when the filter is serviced.

14. The filter of claim 10, wherein the flow pattern is a vortex.

15. The filter of claim 10, wherein the baffle comprises a plurality of radially extended annular spacer plates.

16. The filter of claim 10, wherein the magnetic array comprises annular rings.

17. The filter of claim 10, wherein the bottom plate further comprises a port constructed and arranged to allow compressed gas to enter the filter housing.
